(19) United States
(12) Patent Application Publication
(10) Pub. No.: US 2009/0317619 A1
(43) Pub. Date: Dec. 24, 2009

(54) AEROGEL MATERIALS BASED ON METAL OXIDES AND COMPOSITES THEREOF

(76) Inventors: Roberta Di Monte, Trieste (IT); Jan Kaspar, Trieste (IT)

Correspondence Address: Steinfl & Bruno, 301 N Lake Ave Ste 810, Pasadena, CA, 91101, US

(21) Appl. No.: 12/520,529

(22) PCT Filed: Dec. 20, 2007
(86) PCT No.: PCT/EP2007/064310

§ 371 Date: Jun. 19, 2009

(30) Foreign Application Priority Data
Dec. 22, 2006 (IT) PD2006A000465

(51) Int. Cl. B32B 3/26; C03C 3/062

(52) U.S. Cl. 428/315.7; 501/12

(57) ABSTRACT

The present invention describes a new class of high porosity materials with aerogel properties, based on metal oxides and their composites, possessing a high surface area and a high pore volume distributed within a specific pore diameter range. The pore distribution is monomodal and the porosity of the material is greater than 80%, conferring aerogel properties thereon while the absence of micropores (pores less than 2 nm in diameter) confers a high thermal stability to these materials. The characteristics of the product, including a low, if not zero, macroporosity, confer on the material a low dustiness compared to conventional aerogels, thus enabling them to be used effectively in production cycles.

### FIELD OF THE INVENTION

The invention relates to new materials based on metal oxides and their composites, and in particular, but not exclusively, to doped and non-doped aluminas having a porosity such as to confer thereon aerogel properties as well as thermal stability, thermal insulation property and low dustiness. The invention also relates to a method for their preparation.

### STATE OF THE ART

A gel can be described as a three-dimensional polymer of contiguous particles of a solid (mostly silicate or non-silicate single or mixed metal oxides and their nanocomposites) mixed with the contiguous liquid phase that fills the pores of the material. Said liquid phase can be, for example, water or alcohol or a mixture of the two. The terms hydrogel and alcogel hence describe a gel in which the pores are filled with water or with an alcohol respectively. For example in U.S. Pat. No. 3,634,332 the term hydrogel refers to a gel where the water is the main component and corresponds to 80-95% by weight.

On the other hand, a gel from which the liquid phase is removed by substitution with a gas is generally defined as a xerogel. The liquid is evaporated at a temperature lower than the critical temperature, and the surface tension which generated during the evaporation process induces a significant collapse of the original porous structure to obtain low porosity materials, typically lower than 80%. With regard to the term “aerogel”, this was coined by S. S. Kistler in U.S. Pat. No. 2,188,007 when referring to high porosity materials prepared from a gel dried by operating under supercritical conditions. The liquid is removed from the gel under supercritical conditions to avoid pore collapse due to the surface tension of the liquid, thereby obtaining high porosity materials, with porosity greater than 80%. Under these conditions there is no phase discontinuity between liquid and gas and, as a consequence, given the absence of interface between the liquid and gaseous phases, surface tension is absent so collapse of the porous structure is avoided. This process for preparing high porosity materials is normally known as “supercritical drying”.

This production process is very costly because of the reaction conditions required. For example, the critical pressure of ethanol, used as a solvent for preparing the aerogel material, is around 65 atm, while its critical temperature is 216° C. In order to lower the costs of the supercritical treatment, liquid carbon dioxide can be used as the solvent in place of an alcohol. For example an alcogel is prepared in U.S. Pat. No. 4,667,417 which is treated with liquid CO₂ to replace the solvent in the pores, then the material thus obtained is heated to above 37° C. (the critical temperature of CO₂) so as to apply the supercritical drying process. This process has the advantage of being able to conduct supercritical drying at low temperatures, although it should be noted that pressures higher than the critical pressure (73 atm) must be used.

With the purpose of further lowering the production costs of aerogel materials, gel drying techniques operating at atmospheric pressure have been developed [A. C. Pierre and G. M. Pajonk. Chemistry of aerogels and their applications. Chem. Rev. 102 (11):4243-4265, 2002], where the surface of the pores is modified via a silanization process to render it hydrophobic. This process is often used in the production of commercial aerogel-type materials. So-called “drying control chemical additives (DCCA)” such as glycerol, formamide, diethylformamide, oxalic acid and others have been used for the same purpose [H. D. Gesser and P. C. Goswami. Aerogels and related porous materials. Chem. Rev. 89:765-788, 1989]. The essential technical characteristic that determines the properties of these mainly oxide-based materials, with or without silica, and their nanocomposites, is porosity. This is the volume fraction of a sample of material that corresponds to the pore volume. If this fraction is greater than 0.80, some unique characteristics can be observed such as unusual acoustic properties (the speed of sound is less than 100 m/s) and a low thermal conductivity, typically less than 0.05 W/m° C. Adsorbent properties also can be included in the list. Moreover, said materials are also known to be excellent catalyst supports.

The most important applications of aerogels are however correlated to their high thermal and acoustic insulation capacity [J. Fricke and T. Tillotson. Aerogels: Production, characterization, and applications. Thin Solid Films 297 (1-2):212-223, 1997; A. C. Pierre and G. M. Pajonk, 2002 ref. cit.]. The use of aerogels as ultra-efficient insulators is related to two essential characteristics which determine the aforementioned properties. These characteristics are: i) high material porosity, resulting in a high air content in the sample, which in itself acts as a thermal insulator, and ii) appropriate diameter of the pores (Dₚ) which should have a diameter of less than about 140 nm, this being an essential condition for reducing to a minimum the thermal conductivity of the gaseous phase. In this respect, if the material exhibits a porosity with pores having a Dₚ>140 nm, the thermal conductivity is about 3 orders of magnitude greater than the case in which Dₚ<140 nm. Indeed, as reported in [B. E. Yoldas, M. J. Annen, and J. Bostaph. Chemical engineering of aerogel morphology formed under nonsupercritical conditions for thermal insulation. Chem. Mater. 12 (8):2475-2484, 2000], the heat transferred through a porous material (λ′ₜ) is the sum of the heat transferred through the solid phase (λ′ₛ) and through the gaseous phase (λ′_{g}) while other contributing factors can be ignored.

Regarding the transfer in the solid phase, this is described by the relationship:

λ′ₛ=λₛ⁰×χₛ×(νₚ/ν_{d})

Pore size influences conductivity of the gaseous phase. For a Dₚ>140 nm this is found to be:

λ′_{g}≈2.5×10⁻²×χ′_{g}

Conversely, for materials having pores of Dₚ<140 nm, conductivity is given by the expression:

λ_{g}≈1.7×10⁻⁵×χ_{g}×Dₚ

A reduction of three orders of magnitude in the gas conductivity value is noted when considering materials with pores of Dₚ<140 nm.

Therefore materials must be produced with porosity located exclusively at Dₚ<140 nm to maximize the insulation potential of the system while simultaneously avoiding microporosity formation which, together with its amorphous nature, limits the thermal stability of the aerogel material.

It should also be noted that the conventional classification of pores according to their size is the following: micropores (Dₚ<2 nm); mesopores (2 nm<Dₚ<50 nm); macropores (Dₚ>50 nm) [G. Leofanti e al., Surface area and pore texture of catalysts. Catalysis Today 41:207, 1998].

With the purpose of maximizing aerogel porosity, a number of studies have been carried out on the efficiency of specific treatments for inducing the required porosity. It should further be noted that most of said studies refer to aerogels with a high silica content. Indeed, commercial aerogel products are mostly silica-based, while materials based on other metal oxides have few applications. This is due to the fact that hydrolysis of the gel precursors based on silica-free materials is typically very rapid, leading to relatively dense gels and hence, after suitable drying, aerogels with relatively low porosity compared with those based on silica are obtained [A. C. Pierre and G. M. Pajonk, 2002 ref. cit.].

It should be noted, however, that for applications in which fire resistance and/or resistance to very high temperatures is required, the provision of aerogel-type materials with low SiO₂ content or materials in which SiO₂ is absent is very important. Indeed, SiO₂ based aerogels are typically amorphous and as a consequence if accidentally exposed to very high temperatures they could potentially crystallize to form silica based fibres, a potential danger to health. With regard to preparative methods for aerogels with a low SiO₂ content or SiO₂-free, the importance of supercritical treatment on final product porosity is illustrated in [H. Hirashima, C. Kojima, and H. Imai. Application of alumina aerogels as catalysts. Journal of Sol-Gel Science and Technology 8:843-846, 1997] where it was observed that upon application of supercritical treatment the final porosity increases from 48% to 95%. The samples thus prepared exhibit a bimodal pore distribution, with a considerable micropore contribution and a modest degree of crystallinity [H. Hirashima, H. Imai, and V. Balek. Characterization of alumina gel catalysts by emanation thermal analysis (ETA). Journal of Sol-Gel Science and Technology 19: 399-402, 2000].

French patent No. 1,587,006 describes the preparation of an aerogel by hydrolysis of an alcoholate followed by solvent evaporation under supercritical conditions. It is important to note that the typical characteristic of said preparation processes for aerogels is that, while having high pore volumes, and hence high total porosities, they exhibit a high macropore content as shown by the large difference between pore volume values measured with a mercury porosimeter and those measured with a gas porosimeter, using nitrogen absorption. This latter is the method of choice for determining the volume and distribution of the micro- and mesopores, while the mercury porosimetry technique is suitable for characterizing pores of greater diameter, typically in the large-sized mesopore and macropore regions.

J. Walendziewski et al. [J. Walendziewski M. Stolarski, M. Steininger, and B. Pniak. Synthesis and properties of alumina aerogels. Reaction Kinetics and Catalysis Letters 66: 71-77, 1999] give another example of an alumina aerogel obtained with synthesis methods that employs a supercritical treatment which, after calcination at 500° C., has the following properties: the material is amorphous and the predominant porosity is of macro type (Dₚ>>100 nm) as determined by mercury porosimetry measurements. Within the mesopore range, useful for thermal insulation purposes, the cumulative pore volume is 2.32 ml/g.

M. Goto, Y. Machino, and T. Hirose [Preparation of SiO₂ and NiO/Al₂O₃ aerogels by supercritical CO₂ drying and their catalytic activity, Microporous Materials 7 (1):41-49, 1996] report on the pore distribution achieved after a supercritical drying process, which showed a high degree of macroporosity.

An alumina based aerogel material is described in U.S. Pat. No. 6,620,458. In this patent the alumina aerogel is defined as such if the porosity is greater than 80%. The alumina is prepared in monolith form, the porosity therefore being determined in this case from the geometric volume of the monolith, hence also including macroporosity. Aluminas, prepared by precipitation, with high pore volume and thermal stability are also described in U.S. Pat. No. 5,397,758, though, as demonstrated in the patent, they exhibit a bimodal pore distribution with a significant fraction of pores having a diameter greater than 140 nm.

Typically, materials produced via aerogels are amorphous and this limits their thermal stability as on heat treatment they may crystallise with consequent loss of porosity, even though in a few cases materials based on partially crystalline TiO₂, Al₂O₃ and ZrO₂ have been produced.

For alumina based materials, N. Husing and U. Schubert [Aerogels airy materials: Chemistry, structure, and properties. Angewandte Chemie-International Edition 37 (1-2):23-45, 1998] report a density of 0.13-0.18 g/ml and a pore diameter of 10 nm, while ZrO₂-based materials exhibit a density of 0.2-0.3 g/ml and a pore diameter of 20 nm. Both cases refer to systems with a high percentage of amorphous phase, which limits their thermal stability.

Synthesis of zirconia via aerogel followed by calcination at 500° C. gives rise to an aerogel type oxide with a pore volume of less than 1.3 ml/g and a pore diameter of between 5 and 30 nm. The presence of alkoxides requires that the calcination is conducted at temperatures higher than 500° C., notwithstanding this a final product containing carbonaceous residues is obtained [C. Stocker and A. Baiker. Zirconian aerogels: effect of acid-to-alkoxide ratio, alcoholic solvent and supercritical drying method on structural properties. Journal of Non-Crystalline Solids 223 (3):165-178, 1998].

An alumina aerogel was prepared using the DCCA principle already referred to [L. H. Gan, Z. J. Xu, Y. Feng, and L. W. Chen. Synthesis of alumina aerogels by ambient drying method and control of their structures. Journal of Porous Materials 12 (4):317-321, 2005], however, once again the low densities achieved are due to the presence of macropores: in fact the density is calculated using the apparent volume of the aerogel, while a pore volume of 0.77 ml/g is calculated from an analysis of the N₂ absorption isotherm, confirming that also in this case the synthesis gives rise to a solid in which macropores are the main contributors to total aerogel porosity.

In a recent patent application (WO 2006/070203), a process for preparing materials with aerogel characteristics was described in which addition of H₂O₂ to the Al₂O₃ precipitation process promotes increased formation of porosity in the material, i.e., up to 2.6 ml/g after calcination at 700° C. for 5 hours. In this case the synthesis, as claimed in the patent application, takes place with formation of a hydrogel. Specifically, during the synthesis process the precursor is dissolved in water, H₂O₂ is added and this solution is added to aqueous ammonia. In this manner a hydrogel is obtained which is treated in alcohol, typically 2-propanol, first at room temperature and then under reflux for 5-24 hours to remove water from the reaction environment, thus promoting high porosity.

Precipitation of the precursor in hydrogel form (the H₂O content is >95% in the case of the claimed process in WO2006/070203) does not however enable materials with a porosity greater than 3.0 ml/g to be produced and, furthermore, it confers on the product a marked and undesirable porosity in the macropore region.

The high macropore contribution also confers a dusty appearance on the material which requires the use of anti-dust protection. As reported in EP 0464627, the use of alumina with a pore volume greater than 2.5 ml/g presents considerable technical difficulties due to its pulverulence.

A further limitation of the process claimed in WO2006/070203 is related to the need to use very high quantities of absolute 2-propanol, i.e. 1.2 L/5 g of product, in addition to acetone use (400 ml/5 g of product), in order to consolidate the structure of the prepared hydrogel with the aim of obtaining, after the drying and subsequent calcination, a product of maximum porosity.

The purpose of the present invention is the preparation of an aerogel material having a porosity greater than 80% in which said porosity is found principally in the mesopore region and which exhibits low or no microporosity and/or macroporosity; with the aim of obtaining aerogels with the advantageous properties in terms of thermal stability and/or thermal insulation and/or pulverulence.

A further purpose of the present invention is the preparation of aerogel materials based on single or mixed metal oxides and composites thereof without or with a low content of SiO₂.

A further purpose of the present invention is the establishment of an efficient and easily industrialized process for the preparation of aerogel materials having the previously stated characteristics.

### SUMMARY

The materials based on crystalline metal oxides or composites thereof having high porosity and possessing high surface area and high pore volume distributed within a specific range of pore diameters, of the present invention, fulfil the purposes of the invention by presenting the aforementioned advantageous properties required in addition to the typical aerogel properties, while their preparation method, another aspect of the present invention, allows them to be prepared efficiently and under easily industrialized process conditions. In particular, the advantageous properties of these aerogel materials are attributable to a monomodal pore distribution, centred typically within the range from 5 to 140 nm (mesopore region), with more than 95% of pores present in the material having a Dₚ (pore diameter) within said range, i.e. less than 140 nm. The porosity of the materials is greater than or equal to 80% which confers on them aerogel properties. Moreover the materials are characterized by the absence of micropores (pores less than 2 nm in diameter) which confers on them a high thermal stability, while the absence of macroporosity confers on the material a low pulverulence compared with conventional aerogels, facilitating its use in different production cycles.

An aspect of the invention is therefore an aerogel material based on compositions consisting of a single or mixed metal oxide or a composite thereof in which the metal component consists of a single element or a combination of up to six elements selected from the alkali metals, the alkaline earth metals, the lanthanides, the actinides, the transition metals, the metals of group 13 (IIIA) having, after calcination at a temperature greater than 300° C. and less than 1100° C., aerogel characteristics with a porosity equal or greater than 80% in which at least 90% of the total pore volume consists of pores with a pore diameter from 5 to 140 nm and in which the contribution of macropores with pore diameters ranging from 200 to 10,000 nm is less than 10% of the total pore volume.

Preferred metals for the metal oxides or the composites thereof are preferably selected from the group consisting of Al, Zr, Ti, La, Y, Ta, Nb, Mn, Th, Ce, Pr, Nd, Eu, Gd, Tb, Sm, Dy, Ho, Er, Tm, Yb, Lu, Mg, Ca, Sr, Ba, Na, K, Rb and more preferably Al, Zr, Cr or a combination thereof.

Optionally the aerogel material of the present invention can further comprise SiO₂ in a quantity not greater than 10% of the total weight of the composition.

A further aspect of the present invention is a method for preparing an aerogel material according to the invention comprising at least the steps of: a) preparing the solution of oxide precursor or composite in H₂O₂ to which an alcohol or an azeotropic mixture consisting of H₂O and an alcohol is added; b) preparing a hydroalcogel by treating the previously obtained solution with a base; c) filtering off the solid obtained; d) calcining thereof at a temperature within the range from 300° C. to 1100° C.

### BRIEF DESCRIPTION OF THE FIGURES

FIG. 1: the figure shows the principle of heat diffusion within an infinite flat plate.

FIG. 2: the figure shows an outline of the instrument used for measuring thermal conductivity.

FIG. 3: the figure shows the analysis of macropores by mercury porosimetry measurement carried out on: aerogel material of example 1 (A); aerogel material of comparative example 1 (B); aerogel material of comparative example 2 (C); the pore region of Dₚ>140 nm is indicated.

FIG. 4: the figure shows a comparison of pore distribution vs. pore diameter obtained from N₂ absorption measurements in: aerogel material of example 1 (A) and commercial aerogel (Cabot) (B).

FIG. 5: the figure shows an XRD of the ZrO₂(10% w/w)/Al₂O₃ sample of example 3 calcined at 900° C. Two phases are observed: tetragonal zirconia with particle size of 6 nm and a θ-Al₂O₃ phase with particle size of 5 nm. Porosity of the nanocomposite is 89%.

### TERMINOLOGY

Through out the present text solid materials based on metal oxides and their composites which have a porosity greater than 80% are defined with the tem(s) aerogel(s), as reported in L. W. Hrubesh and J. F. Poco [Thin Aerogel Films for Optical, Thermal, Acoustic and Electronic Applications. Journal of Non-Crystalline Solids 188 (1-2):46-53, 1995] and U.S. Pat. No. 6,620,458.

With regard to the aforementioned importance of the Dₚ=140 nm, in the following text we will define pores with 2 nm<Dₚ<140 nm as mesopores and the with Dₚ>140 nm as macropores.

For the definitions of the terms hydrogel, alcogel and xerogel, see the previously given definitions in State of the Art.

The term hydroalcogel describes a gel that contains a solvent consisting of a mixture of water and an alcohol, in which the alcohol/water ratio in the solution is between 0.25 and 9.

The term PR is used to indicate 95-99.9% 2-propanol, while PR-AZ means the azeotrope of water and 2-propanol obtained by distillation of a mixture, recovered from the synthesis process, containing about 12% w/w of water.

### DETAILED DESCRIPTION OF THE INVENTION

The objectives and advantages of the aerogel materials and their preparation method, according to the present invention, will be better understood over the course of the following detailed description where, by way of non-limiting illustration of the invention, some examples of materials obtained with the process and their characteristics will be described. The materials with aerogel properties of the invention possess a monomodal-type pore distribution with at least 90%, but preferably 95%, of pores featuring a pore diameter in the range from 5 to 140 nm and with a relative porosity, calculated as described in the following, greater than or equal to 80%. These materials, which appear in crystalline form, can conveniently be prepared by a method that does not use drying and/or treatments under supercritical conditions, nor does it require surface modifications. The preparation method of said materials is very flexible and allows both single and mixed metal oxides to be prepared, comprising from one to six elements, or composites thereof, possessing the aforesaid properties.

For this purpose, the metals are chosen from alkali metals, alkaline earth metals, lanthanides, actinides, transition metals and metals of group 13(IIIA), in accordance with IUPAC nomenclature (International Union of Pure and Applied Chemistry) that is elements of the boron group. Preferred among these metals are alkali metals such as Na, K, Rb, alkaline earth metals such as Mg, Ca, Sr and Ba, lanthanides such as Ce, Pr, Nd, Eu, Gd, Tb, Sm, Dy, Ho, Er, Tm, Yb, Lu, actinides such as Th, transition metals such as Zr, Ti, La, Y, Ta, Nb, Mn, metals of group 13(IIIA) such as Al. The most preferred of these metals are Al, Zr and Ce and said metals can be the only metal elements in the metal oxide, or they can be associated with the other aforementioned metal elements or with each other to form mixed oxides or composites usable for preparing the aerogel materials of the invention.

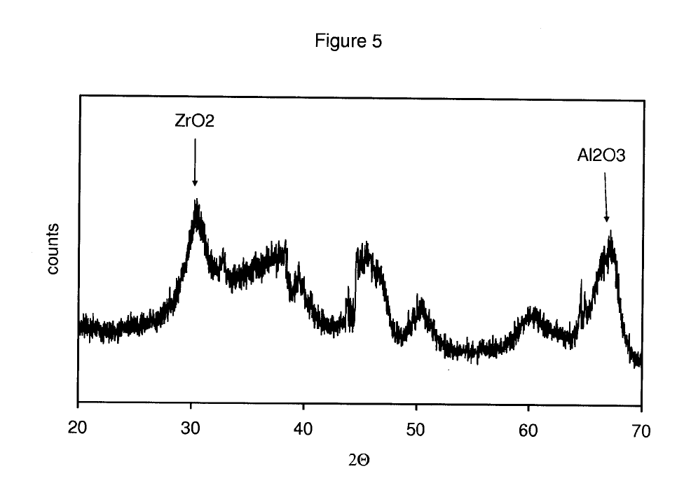

In particular, the aerogel materials of the invention can be based on single oxides such as CeO₂ and Al₂O₃, mixed oxides such as CeₓZr₁₋ₓO₂, ZrₓY₁₋ₓO_{y}, Al_{0.92}La_{0.08}O_{1.5} and inorganic composites thereof, such as ZrO₂(10% w/w)/Al₂O₃ i.e. Al_{0.96}Zr_{0.04}O_{1.52}. In this last case, it should be noted that the starting mixed oxide, owing to the calcination, gives rise to a system defined as a nanocomposite, being characterized by the presence of two or more distinct phases consisting of particles of nanometric size; in the cited example, two crystallographically distinct phases of ZrO₂ and Al₂O₃ are formed (FIG. 5). Said compositions are to be considered only as examples of general applicability of the preparation method described herein, and must not be considered as limiting the range of compositions to which the aerogel preparation of the present invention can be applied.

The metal oxide-based materials or their composites having aerogel properties of the present invention can optionally also contain SiO₂ in a small quantity and in any case in a quantity not greater than 10% w/w on the total weight.

The present invention relates to the preparation of highly porous aerogel-type oxides materials, comprising an intermediate hydroalcogel preparation step as aforedefined, i.e, a hydroalcogel in which the solvent consists of an alcohol and water mixture, preferably in a volume ratio of between 0.25 and 9.

The process used allows high porosity oxides materials to be prepared, by using reduced amounts of solvent compared to the state of the art described in WO 2006/070203, operating at room pressure and recycling the solvent used for the synthesis via a distillation process.

The product preparation method of the present invention comprises the formation of a hydroalcogel as a process intermediate. In particular, the process for preparing the aerogel materials comprises at least the steps of:

a) preparing a solution of at least one precursor of the oxide or the composites in H₂O₂ to which a solvent, selected from an alcohol or an azeotropic mixture consisting of H₂O and an alcohol, is subsequently added;
b) preparing a hydroalcogel by treating the previously obtained solution with a base preferably diluted in alcohol or in the azeotropic mixture used in the preceding step;
c) filtering off the solid obtained;
d) calcining thereof at a temperature within the range from 300° C. to 1100° C.

Optionally, after the step of filtering off the solid, a step of solid washing, using an organic solvent, preferably an alcohol, followed by drying can be undertaken.

For the process of the invention the preferred alcohols are selected from the group consisting of methyl alcohol, ethyl alcohol, propyl alcohol, isopropyl alcohol, being the isopropyl alcohol the most preferred. The temperatures usable for drying are between 80° C. and 200° C.

With the aforedescribed process, aerogel materials can be obtained with a porosity even greater than 90%.

Typically, an aerogel material of the invention can be prepared as described below:

A solution of the precursor(s) of an oxide or a composite in hydrogen peroxide is prepared, in which the ratios of H₂O₂ to metal element are between 2 and 12 and preferably between 3 and 6; this solution is then diluted with a solvent selected from alcohols and preferably from the group consisting of methyl alcohol (MeOH), ethyl alcohol (EtOH), propyl alcohol (PrOH), isopropyl alcohol (iPrOH) or an azeotrope thereof with water, in which the alcohol can be up to 90%, more preferably between 25% and 90%. For reasons of economics, the solvent is even more preferably PR-AZ as previously described. The preferred characteristics of the thus obtained solution are: [Metal]>0.1 M, [H₂O₂]/[Metal]>1, 0.25<Volume(alcohol)/Volume(H₂O)<9.

A hydroalcogel is then prepared by treating the previously obtained solution with a base. The preferred base is concentrated ammonia, preferably at a 25-30% concentration in water. It is preferable, but not necessary, to dilute it in a solvent chosen among MeOH, EtOH, PrOH, iPrOH or in an azeotropic mixture thereof as in the preceding step, more preferably in PR-AZ. Precipitation of the solid preferably occurs by adding the solution from point a) to the base at ambient temperature. On termination of the addition the following is preferably achieved: 0.25<Volume(alcohol)/Volume(H₂O)≦9.

The obtained material is filtered off and the solid obtained is re-dispersed in an organic solvent chosen preferably from the aforementioned alcohols or an azeotropic mixture of said organic solvents and water, preferably using PR-AZ, then filtered off. Said operation can be repeated several times. Furthermore, it is preferable to treat the product thus obtained at the reflux temperature of the alcohol, preferably isopropanol, for a period of more than 2 hours but less than 24 hours. After filtration the solid is dried for 4 to 24 hours at between 80° C. and 200° C., preferably at 120° C. Drying is followed by its calcining at a temperature between 300° C. and 1100° C. for a time between 0.1 and 24 hours, preferably between 5 and 10 hours.

By way of non-limiting illustration of the invention, the preparation of some aerogel materials of the invention is described below and their characteristics compared with the materials obtained by the process of the known art described in WO2006/070203.

### Examples Prepared in Accordance with the Present Invention

### Example 1

### Synthesis of 5 g of Al₂O₃ (PRHAl100)

37.13 g of aluminium nitrate nonahydrate are dissolved in 60 ml of hydrogen peroxide (Al:H₂O₂=1:6). 90 ml of an azeotropic isopropanol (88%) and water (12%) mixture (PR-AZ) are added.

The solution thus obtained is added to a solution formed from 60 ml of 30% w/w ammonia and 40 ml of PR-AZ, using an addition rate of 2.5 ml/min to form a hydroalcogel with a water content not greater than 65%. The product is then filtered off and dispersed in 100 ml of PR-AZ, this operation being repeated twice. The final filtrate is then treated in 100 ml of pure 2-propanol under reflux for 8 hours, then cooled and filtered. The product is then dried at 120° C. for 4 hours. The solid thus obtained is calcined at 700° C. for 10 hours. The characteristics of the aerogel thus obtained are given in Table 1 to follow. It should be noted that the pore volume is greater than 3.0 ml/g with a simultaneous moderate contribution by macropores (Table 2). It is important to note that the properties described in Table 1 do not undergo significant changes even when the calcination temperature is increased to 900° C., demonstrating an excellent thermal stability of the material.

### Example 2

### Synthesis of 5 g of Al_{0.92}La_{0.08}Oₓ

29.07 g of aluminium nitrate nonahydrate and 1.09 g of lanthanum nitrate are dissolved in 60 ml of hydrogen peroxide (Al:H₂O₂=1:6) and 90 ml of (PR-AZ) are then added. The solution thus obtained is added to a solution formed from 60 ml of 30% w/w ammonia and 40 ml of PR-AZ, using an addition rate of 2.5 ml/min to form a hydroalcogel. The product is then filtered off and re-dispersed in 100 ml of PR-AZ, this operation being repeated twice. The final filtrate is then treated in 100 ml of pure 2-propanol under reflux for 8 hours, then cooled, filtered and dried at 120° C. for 4 hours. Calcination is conducted at 700° C. for 10 hours.

### Example 3

### Synthesis of 5 g of Al_{0.96}Zr_{0.04}O_{1.52} (ZrO₂(10 wt %)/Al₂O₃)

33.44 g of aluminium nitrate nonahydrate and 2.50 g of a 20.15% w/w zirconium nitrate solution are dissolved in 60 ml of hydrogen peroxide (Al:H₂O₂=1:6) and 90 ml of (PR-AZ) are then added. The solution thus obtained is added to a solution formed from 60 ml of 30% w/w ammonia and 40 ml of PR-AZ, using an addition rate of 2.5 ml/min to form a hydroalcogel. The product is then filtered off and re-dispersed in 100 ml of PR-AZ, this operation being repeated twice. The final filtrate is then treated in 100 ml of pure 2-propanol under reflux for 8 hours, then cooled, filtered and dried at 120° C. for 4 hours. By calcination of the product obtained at temperatures above 700° C., the formation of a nanocomposite product is observed which exhibits crystallographic phases due to the Al₂O₃ and ZrO₂ (Table 1).

### Example 4

### Synthesis of 5 g of Ce_{0.2}Zr_{0.8}O₂

6.05 g of a cerium nitrate solution (21.5 wt % CeO₂) and 18.41 g of a 20.15 wt % zirconium nitrate solution are diluted in 50 ml of hydrogen peroxide and 100 ml of (PR-AZ) are then added. The solution thus obtained is added to a solution formed from 60 ml of 30% w/w ammonia and 40 ml of PR-AZ, using an addition rate of 2.5 ml/min to form a hydroalcogel. The product is then filtered off and re-dispersed in 100 ml of PR-AZ, this operation being repeated twice. The final filtrate is then treated in 100 ml of pure 2-propanol under reflux for 8 hours, then cooled, filtered and dried at 120° C. for 4 hours (Table 1). Calcination is conducted at 300° C. for 5 hours.

### Example 5

### Synthesis of 5 g of CeO₂

23.29 g of a cerium nitrate solution (21.5 wt % CeO₂) are diluted in 50 ml of 35% hydrogen peroxide and 100 ml of (PR-AZ) are then added. The solution thus obtained is added to 60 ml of 30% wt ammonia diluted in 40 ml of PR-AZ, using an addition rate of 2.5 ml/min to form a hydroalcogel. The product is then filtered off and re-dispersed in 100 ml of PR-AZ, this operation being repeated twice. The final filtrate is then treated in 100 ml of pure 2-propanol under reflux for 8 hours, then cooled, filtered and dried at 120° C. for 4 hours. The sample is then calcined at 300° C. for 10 hours (Table 1).

### Example 6

### Synthesis of 5 g of Zr_{0.85}Ti_{0.15}O₂

21.13 g of a zirconium nitrate solution (20.15 wt % ZrO₂) together with 4.95 g of a titanium trichloride solution (15 wt % TiCl₃) are diluted in 60 ml of 30% hydrogen peroxide and 90 ml of (PR-AZ) are then added. The solution thus obtained is added to 60 ml of 30 wt % ammonia diluted in 40 ml PR-AZ, using an addition rate of 2.5 ml/min to form a hydroalcogel. The product is then filtered off and re-dispersed in 100 ml of PR-AZ, this operation being repeated twice. The final filtrate is then treated in 100 ml of pure 2-propanol under reflux for 8 hours, then cooled, filtered and dried at 120° C. for 4 hours. The sample is then calcined at 300° C. for 5 hours.

### Example 7

### Synthesis of 5 g of Zr_{0.92}Y_{0.08}O_{1.96}

22.98 g of a zirconium nitrate solution (20.15 wt % ZrO₂) together with 1.21 g of yttrium nitrate are diluted in 60 ml of 30% hydrogen peroxide and 90 ml of (PR-AZ) are then added. The solution thus obtained is added to 60 ml of 30 wt % ammonia diluted in 40 ml PR-AZ, using an addition rate of 2.5 ml/min to form a hydroalcogel. The product is then filtered off and re-dispersed in 100 ml of PR-AZ, this operation being repeated twice. The final filtrate is then treated in 100 ml of pure 2-propanol under reflux for 8 hours, then cooled, filtered and dried at 120° C. for 4 hours. The sample is then calcined at 300° C. for 5 hours.

### Example 8

### Synthesis of 5 g of Ce_{0.2}La_{0.05}Zr_{0.75}O_{1.975} (CeLaZr)

16.98 g of a zirconium nitrate solution (20.15 wt % ZrO₂) together with 1.55 g of a lanthanum nitrate solution (20 wt % La₂O₃) and 5.92 g of a cerium nitrate solution (21.53 wt % CeO₂) are diluted in 60 ml of 30% hydrogen peroxide, and 90 ml of PR-AZ are then added. The solution thus obtained is added to a solution formed from 60 ml of 30% w/w ammonia and 40 ml of PR-AZ, using an addition rate of 2.5 ml/min to form a hydroalcogel. The product is then filtered off and re-dispersed in 100 ml of PR-AZ, this operation being repeated twice. The final filtrate is then treated in 100 ml of pure 2-propanol under reflux for 8 hours, then cooled, filtered and dried at 120° C. for 4 hours. The sample is then calcined at 300° C. for 5 hours.

### Example 9

### Synthesis of 5 g of SiO₂(5%)/Al₂O₃

1.64 g of a solution of colloidal silicic acid (15.23 wt % SiO₂) together with 35.29 g of aluminium nitrate nonahydrate are diluted in 60 ml of 30% hydrogen peroxide and 90 ml of (PR-AZ) are then added. The solution thus obtained is added to a solution formed from 60 ml of 30% w/w ammonia and 40 ml of PR-AZ, using an addition rate of 2.5 ml/min to form a hydroalcogel. The product is then filtered off and re-dispersed in 100 ml of PR-AZ, this operation being repeated twice. The final filtrate is then treated in 100 ml of pure 2-propanol under reflux for 8 hours, then cooled, filtered and dried at 120° C. for 4 hours. The sample is then calcined at 700° C. for 5 hours.

### COMPARATIVE EXAMPLES

For the synthesis, the reaction employs the conditions described in application WO 2006/070203 chosen among those which generate the maximum pore volume and are comparable to the preparation conditions of the present invention.

### Comparative Example 1

### Synthesis of 5 g of Al₂O₃

37.13 g of aluminium nitrate nonahydrate are dissolved in 130 ml of water; 30 ml of hydrogen peroxide (Al:H₂O₂=1:3) are then added. The solution thus obtained is added to 60 ml of 30% w/w ammonia, using an addition rate of 2.5 ml/min to form a hydrogel with a water content greater than 90%. The product is then filtered off and dispersed in 400 ml of pure isopropanol, this operation being repeated twice. The final filtrate is then treated in 400 ml of pure isopropanol under reflux for 20 hours, then cooled and filtered. The product is then re-dispersed in 400 ml of acetone, filtered and dried at 120° C. for 4 hours.

The solid thus obtained is calcined at 700° C. for 5 hours. The characteristics of the product thus obtained are compared in Table 2 with the aerogel of example 1. It should be noted that comparative example 1, while exhibiting a higher pore volume value i.e. greater than 4 ml/g (low apparent density) as determined by measurement with a mercury porosimeter, actually exhibits a relatively low pore volume within the desired range as determined by gas porosimetry, compared with example 1; this indicates the considerable macropore contribution to the total volume in the case of comparative example 1. Mercury and gas porosimetry measurements show that of the total pore volume of 4.7 ml/g, hence also including macropores, only 2.6 ml/g are due to pores within the useful range (Table 2). This, as shown in the following, results in a low thermal insulation efficiency for comparative example 1 compared with example 1.

### Comparative Example 2

### Synthesis of 5 g of Al₂O₃ with Use of Recycled Solvents (PR-AZ)

37.13 g of aluminium nitrate nonahydrate are dissolved in 130 ml of water; 30 ml of hydrogen peroxide (Al:H₂O₂=1:3) are then added. The solution thus obtained is added to 60 ml of 30% w/w ammonia using an addition rate of 2.5 ml/min to form a hydrogel with a water content greater than 90%. The product is then filtered off and re-dispersed in 400 ml of PR-AZ, this operation being repeated twice. The final filtrate is treated in 400 ml of pure 2-propanol under reflux for 20 hours, then cooled and filtered off. The product is then re-dispersed in 400 ml of acetone, filtered and dried at 120° C. for 4 hours. The solid thus obtained is calcined at 700° C. for 5 hours.

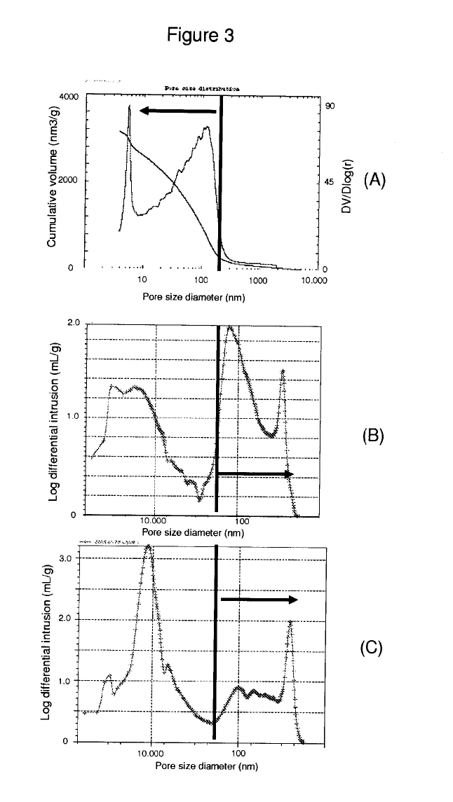

The characteristics of the product thus obtained are given in Table 2 and FIG. 3. It should be noted that there is a strong reduction in porosity due to the use of a recycled solvent (PR-AZ) containing significant quantities of water, compared to comparative example 1 where the use of the same PR-AZ solvent in accordance with the present invention leads to a significantly higher porosity.

Example 1 and comparative example 1 were suitably calcined to obtain comparable pore volume and hence porosity: V_{P}(N₂)=2.40 ml/g, corresponding to a porosity of 90%. The thermal conductivities of the two samples, measured as described hereinafter, are found to be respectively 0.029 and 0.069 W/m ° C. confirming the importance of the specific porosity features as obtained in the present invention.

### Characterization of Aerogel Materials Prepared in the Examples

The porous structure is determined by measuring N₂ adsorption at 77 K. Pore distribution and volume are calculated by using the method described in E. P. Barret, L. G. Joyner, and P. P. Halenda [The Determination of Pore Volume and Area Distributions in Porous Substances. I. Computations from Nitrogen Isotherms. J. Am. Chem. Soc. 73:373-380, 1951], and discussed in Leofanti 1998, ref. cit. and K. S. W. Sing, D. H. Everett, R. A. W. Haul, L. Moscou, R. A. Pierotti, J. Rouquerol, and T. Sieminiewska [Reporting physisorption data for gas/solid systems with special reference to the determination of surface area and porosity. Pure Appl. Chem. 57:603-619, 1985] using the part of the isotherm measured in the desorption phase.

The pore distribution for diameters Dₚ>140 nm, hence also including the macropore region, is determined using mercury porosimetry.

In the present text the relative density (dᵣₑₗ) is defined as the ratio of product density (d) to the density it would have in the absence of porosity, i.e. density determinable by X-ray measurement (d_{XRD}).

$${d}_{rel} ( \% ) = \frac{d}{{d}_{XRD}} \times 100 \qquad [ 1 ]$$

The density of the material is calculated

$$d = \frac{1}{( \frac{1}{{d}_{XRD}} + {V}_{P} ( {N}_{2} ) )} \qquad [ 2 ]$$

where d_{XRD} is the density relative to the crystalline structure (for example if the structure is boehmite or γ-Al₂O₃, the density is 3.03 and 3.63 g/cm³ respectively) and V_{P}(N₂) is the pore volume, expressed in ml/g, obtained from the N₂ adsorption measurement at a temperature of 77 K, as aforedescribed. The density is then calculated taking into consideration the pore volume between 5 and 140 nm. It should be noted that the materials prepared in accordance with the present invention do not have pores of Dₚ<5 nm.

The density measured in this manner is greater than that determined by measuring the monolith geometry since it does not include any packing defects normally present in a monolith, i.e. the presence of macropores. It should be noted that the density typically given in the literature is actually an apparent density, see for example J. F. Poco, J. H. Satcher, and L. W. Hrubesh [Synthesis of high porosity, monolithic alumina aerogels. Journal of Non-Crystalline Solids 285 (1-3):57-63, 2001], in which the density of the material, calculated as the ratio of monolith weight to its geometric volume, is reported. The density calculated in this manner and reported in the publication is 0.37 g/ml; however, by calculating the density using the procedure established in the present invention, a density value of 0.61 g/ml is obtained.

The porosity of the material (P) is defined as:

$$P ( \% ) = \frac{{V}_{P} ( {N}_{2} )}{{V}_{P} ( {N}_{2} ) + \frac{1}{{d}_{XRD}}} \times 100 \qquad [ 3 ]$$

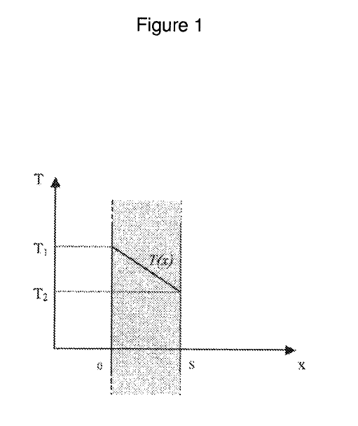

The thermal conductivity is measured by using the principle of heat diffusion through an infinite flat plate (FIG. 1).

The measurements are undertaken on pellets of 13 mm diameter prepared by compressing the powder using a mechanical pelleting machine. The pressure exerted is such that the density of the pellets is equal to or less than that derived from the physisorption measurements. For materials prepared in accordance with the present invention, in order to obtain an apparent density (calculated from the weight and the geometric volume of the pellets) equal to that obtained from N₂ adsorption measurements as aforedefined, it is typically necessary to apply a pressure of 19 Mpa. Thus, a consistent and easily manageable pellet is obtained with a thickness of about 2 mm. It should be noted that said observation denotes a good mechanical strength of the material in that by using the same compression pressure to prepare a pellet with the material prepared as described in comparative example 1, a partial collapse of the porous structure of the sample takes place, an indication of low mechanical strength, which appears to be associated with the presence of macropores. The apparent density (calculated from the pellet volume) is in this case typically greater than that obtained from the N₂ physisorption measurement.

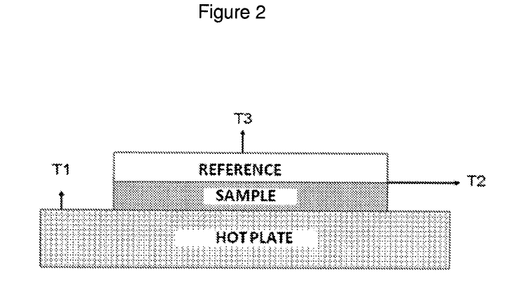

The measurement is conducted by applying the principle of stationary heat flow through a flat plate, using a system maintained at constant temperature, described in FIG. 2.

Fourier's law can be applied in this manner:

$$\dot{q} = - λ \cdot \frac{d {T}_{s}}{d x} \qquad [ 4 ]$$

Where q is the specific heat flow between the faces of the flat plate, λ is the thermal conductivity, dTₛ=T₂−T₁ is the temperature difference between the two walls of the sample to be measured and dx is its thickness.

On coupling the plate of material, the thermal conductivity of which is to be measured, to a reference plate prepared from a material of known conductivity (typically a Ce-TZP pellet) (cerium stabilized zirconia, λ=2 W/K m) and assuming that the heat flow is constant across the two plates:

$${\dot{q}}_{s} = - {λ}_{s} \cdot \frac{d {T}_{s}}{d x} = {\dot{q}}_{rif} = - {λ}_{rif} \cdot \frac{d {T}_{rif}}{d x} \qquad [ 5 ]$$

the thermal conductivities given in Table 3 below are measured experimentally. The subscripts s and rif in equation [5] refer respectively to the sample to be measured and the reference (Ce-TZP).

The Al₂O₃ based materials, prepared according to the present invention and thermally treated at 500-700° C., exhibit porosities greater than 3.0 ml/g with a monomodal pore distribution, whereby more than 95% of the pores are located within a range of pore diameters 5-140 nm, as shown by porosity analysis conducted with a gas and mercury porosimeter respectively.

Said distribution can be measured as:

$$\% pores = \frac{{V}_{P} ( {N}_{2} ) ( < 140 nm )}{{V}_{P} ( Hg )} \times 100 \qquad [ 6 ]$$

where Vₚ(N₂)(<140 nm) and V_{P}(Hg) respectively represent the cumulative pore volume for diameters <140 nm measured by N₂ absorption and the cumulative pore volume determined by mercury porosimetry.

By applying the methods briefly described above to the aerogel materials of the present invention prepared in examples 1-9 and to the aerogel materials prepared according to WO2006/070203 indicated as comparative examples 1 and 2, the following results are obtained.

Table 1 gives the properties of samples with different compositions prepared according to the present invention. It should be noted that in all the cases under consideration, materials possessing a relative porosity greater than or equal to 80% are obtained. There is no evidence of an appreciable presence of pores of Dₚ>140 nm and micropores (Dₚ<2 nm) are absent. The materials are crystalline, as determined by X-ray measurements.

TABLE 1
Properties of the aerogel material samples prepared according to the invention

| | T_{calc} | d_{XRD}, | BET | Vp(N₂) | D̅_{P} | d | Porosity |
|---|---|---|---|---|---|---|---|
| Synthesis | (° C.) | structure⁽¹⁾ | (m²/g) | (cc/g) | (nm)⁽²⁾ | (g/mL) | (%) |
| Ex. 1 | 700 | 3.6, γ | 295 | 3.133 | 33 | 0.28 | 92 |
| Ex. 2 | 700 | 3.0, γ | 311 | 3.172 | 33 | 0.29 | 91 |
| Ex. 3 | 700 | 3.9, γ + TZ | 297 | 3.236 | 35 | 0.29 | 93 |
| Ex. 4 | 300 | 2, TZ | 195 | 1.14 | 19 | 0.77 | 88 |
| Ex. 5 | 300 | 4.0, C | 169 | 0.56 | 121 | 1.4 | 80 |
| Ex. 6 | 300 | TiZr | 92 | 0.95 | 34 | 0.89 | 89 |
| Ex. 7 | 300 | Y—Zr | 196 | 1.33 | 21 | 0.67 | 89 |
| Ex. 8 | 300 | Ce—La—Zr | 209 | 1.12 | 17 | 0.89 | 89 |
| Ex. 9 | 700 | SiAl | 242 | 2.83 | 37 | 0.32 | 91 |

⁽¹⁾a = amorphous, γ. γ-Al₂O₃; TZ: ZrO₂ tetragonal; C: cubic CeO₂, Examples 6-9 are crystalline solid solutions of the respective oxides.
⁽²⁾ D̅_{P} = mean pore diameter determined as described in Barret et al. 1951, ref. cit.

A comparison of the properties of the material prepared according to the present invention (example 1) and comparative examples 1 and 2 (Table 2) clearly indicates that the material prepared according to the present invention exhibits a specific pore distribution with 98% of pores located within the desired range of dimensions particularly useful for thermal insulation properties as discussed above.

It must be highlighted that the properties described in Table 1 are not substantially degraded, not even by treatment at high temperature which can reach 850 and 1100° C. for example 1 and examples 2-3 respectively, demonstrating the excellent thermal stability of the products prepared according to the present invention. It should be noted that in this regard, commercial aerogels typically have a chemically treated surface (silanized) which limits their applicability to low temperature, being often less than 250° C.

The data given in Table 2 show unequivocally that the materials prepared according to the present invention exhibit a unique pore distribution with 98% of pores located within the desired pore range, as previously described. Conversely, comparative examples 1 and 2 clearly show the presence of undesirable macroporosity.

TABLE 2
Comparison of properties and synthesis conditions of example
1 and the comparative examples, calcined at 700° C.

| | | V_{P}(N₂) | | | | |
|---|---|---|---|---|---|---|
| | BET | (<140 nm) | V_{P}(Hg) | D̅_{P} | d | % |
| Sample | (m²/g) | (ml/g) | (ml/g) | (nm) | (g/ml) | pores⁽¹⁾ |
| Ex. 1 | 295 | 3.13 | 3.15 | 33 | 0.29 | 98 |
| Comp. ex. 1 | 317 | 2.60 | 4.72 | 33 | 0.34 | 55 |
| Comp. ex. 2 | 281 | 2.45 | 4.99 | 31 | 0.36 | 49 |

⁽¹⁾Calculated using equation [6]

The thermal insulation properties were measured with the aforedescribed instrumentation, the data relating to the reference materials showing an excellent correspondence between measured and declared values for the reference materials (Table 3).

TABLE 3
Thermal conductivity measurement of materials with conductivity
determined with instrumentation shown in FIG. 2.

| | Measured thermal | Declared |
|---|---|---|
| | conductivity coefficient | conductivity coefficient |
| Sample | [W/m ° C.] (70° C.) | [W/m ° C.] |
| Alumina fibres | 0.042 (±0.01) | 0.058 (at 200° C.) |
| SAFFIL 1600 | | |
| Polyethylene | 0.488 (±0.04) | 0.459 |
| SEBS⁽¹⁾ | 0.25 (±0.08) | 0.2 |
| Natural cork | 0.043 | 0.050-0.043 |
| Cabot nanogel | 0.021 | 0.018 |

⁽¹⁾SEBS: Styrene-ethylene/butylene-styrene

A comparison of the measured conductivity of samples prepared according to the present invention and commercial samples of Al₂O₃ or samples prepared according to the state of the art, clearly demonstrates the superior thermal insulation capacity of the materials prepared according to the present invention which renders them particularly interesting for applications in the field of thermal insulation (Table 4).

TABLE 4
Measurement of thermal conductivity of materials prepared
according to the present invention and comparative examples

| | Measured thermal conductivity |
|---|---|
| Sample (porosity %) | coefficient [W/m K] (70° C.) |
| Ex. 1 | 0.029(±0.005) |
| Ex. 2 | 0.021 |
| Ex. 3 | 0.022(±0.004) |
| Ex. 4 | 0.017 |
| Ex. 6 | 0.016 |
| Ex. 7 | 0.026 |
| Ex. 8 | 0.018 |
| Ex. 9 | 0.025 |
| Comp. ex. 1 | 0.061(±0.008) |
| Comp. ex. 2 | 0.065(±0.009) |
| Commercial alumina - Actibond | 0.27(±0.01) |
| (43%) | |
| Commercial alumina Grace (73%) | 0.076 |
| Comparative ex. 4. commercial | 0.056(±0.004) |
| Ce_{0.2}Zr_{0.8}O₂ (74%) | |
| Comparative ex. 7 commercial | 0.261 |
| Zr_{0.92}Y_{0.08}O_{1.96} (63%) | |
| Comparative ex. 8. | 0.144 |
| Ce_{0.2}La_{0.05}Zr_{0.75}O_{1.975} (58%) | |

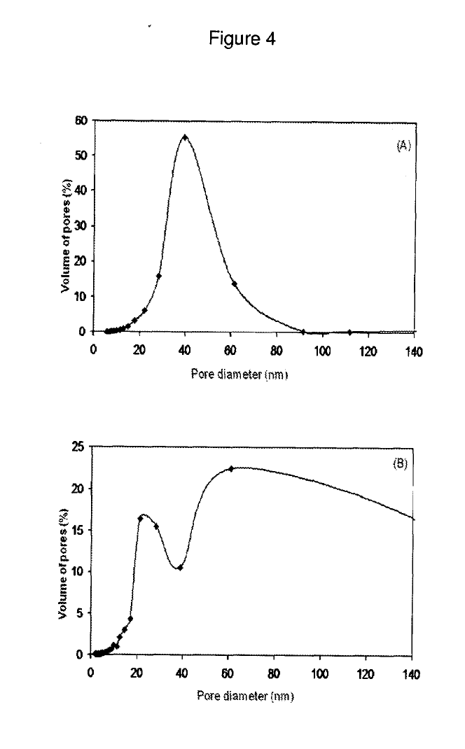

As illustrated in FIG. 3, the product obtained via the hydroalcogel (Example 1) exhibits a monomodal pore distribution with pore diameters located in the 5-140 nm range whereas pores of diameters greater than 140 nm are absent. In contrast, a commercial aerogel has a high porosity with significant fraction of pores with pore diameters greater than 140 nm which also extends into the macropore region (FIG. 4). In this case, the porosity is 94% and exhibits a high porosity due to the presence of macropores.

Although the interpretation is purely indicative and its presumed significance does not compromise the validity of the present invention, it can be hypothesized that the alcohol-metal oxide precursor or composite interaction achieved by using isopropanol and H₂O₂ as the solvent, to dissolve for example Al(NO₃)₃×9H₂O, and which generates the hydroalcogel system, has a fundamental role in achieving an appropriate nanostructuring of the porosity and in obtaining, by drying and calcining, very high pore volumes due to pores with pore diameters located in the 5-140 nm region.

Moreover, said special interaction enables the amount of solvent required to prepare material of high porosity compared to the state of the art to be reduced by 80%. (crf example 1 and comparative example 1), in addition to the fact that for the synthesis, isopropanol, a residue of the precipitate washing process, can be re-used after distillation, while said process modification results in about a 20% loss of pore volume in the samples prepared according to the state of the art (comparative example 2 compared to comparative example 1).

The same comparative example 1 exhibits a significant porosity in the macropore region as determined by mercury porosimetry measurement, where said porosity is found to be absent in example 1 (FIG. 3).

Furthermore, it can be noted that in comparative examples 1 and 2 a hydrogel forms containing about 98% of water. Precipitation of the precursor in the form of a hydrogel (the H₂O content is >95% in the case of the process claimed in WO 2006/070203) does not enable materials with a porosity greater than 3.0 ml/g to be produced, as shown in the present comparative examples 1 and 2 and, moreover, confers on the product a marked and undesirable porosity in the macropore region. It is important to once again note that macroporosity confers on the solid a greater apparent volume than the material prepared according to the invention, but this does not translate into better thermal insulating characteristics. On the contrary, the presence of macropores confers a low mechanical stability to the material so that on subjecting the powder to a compression of 19 Mpa during preparation of the pellet used for thermal conductivity measurements the material is seen to collapse, with an apparent density greater than that measured by N₂ adsorption, as previously established.

1.-37. (canceled)

38. An aerogel material comprising
a composition of at least one metal oxide or a composite thereof, the composition having a metal component of one to six metals selected from the group consisting of alkali metals, alkaline earth metals, lanthanides, actinides, transition metals, and metals of group 13 (IIIA),
wherein
the aerogel material has a porosity equal to or greater than 80%,
at least 90% of the total pore volume consists of pores having a diameter from 5 to 140 nm and
less than 10% of the total pore volume consists of pores having a pore diameter from 200 to 10,000 nm.

39. The aerogel material of claim 38, wherein at least 95% of the total pore volume consists of pores with a pore diameter from 5 to 140 nm and wherein less than 5% of the total pore volume consists of a pore diameter from 200 to 10,000 nm.

40. The aerogel material of claim 39, wherein the aerogel material has a porosity greater than 90%.

41. The aerogel material of claim 38, further comprising SiO₂ up to 10% w/w of the composition.

42. The aerogel material of claim 38, wherein the metals are selected from the group consisting of Al, Zr, Ti, La, V, Ta, Nb, Mn, Th, Ce, Pr, Nd, Eu, Gd, Tb, Sm, Dy, Ho, Er, Tm, Vb, Lu, Mg, Ca, Sr, Ba, Na, K, Rb.

43. The aerogel material of claim 38, wherein the metal is one or more metals selected from the group consisting Al, Zr and Ce.

44. An aerogel material comprising
a composition of at least one metal oxide or a composite thereof, the composition having a metal component of one to six metals selected from the group consisting of alkali metals, alkaline earth metals, lanthanides, actinides, transition metals, metals of group 13 (IIIA),
wherein the aerogel material has
a porosity equal to or greater than 80%,
a pore size distribution such that at least 90% of the total pore volume consists of pores with a pore diameter between 5 and 140 nm and less than 10% of the total pore volume consists of pores with a pore diameter between 200 and 10,000 nm
wherein the pore size distribution is measured as
$$\% pores = \frac{{V}_{P} ( {N}_{2} ) ( 140 nm )}{{V}_{P} ( Hg )} \times 100$$
where
Vp (N2)(140 nm) is the cumulative pore volume of the aerogel material for diameters <140 nm determined by gas porosimetry using N2 adsorption, and
Vp(Hg) is a cumulative pore volume of the aerogel material determined by mercury porosimetry.

45. The aerogel material of claim 44, wherein at least 95% of the total pore volume consists of pores with a pore diameter from 5 to 140 nm and wherein less than 5% of the total pore volume consists of a pore diameter from 200 to 10,000 nm.

46. The aerogel material of claim 44, wherein the aerogel material has a porosity greater than 90%.

47. The aerogel material as claimed in claim 44, further comprising SiO₂ Up to 10% w/w of the composition.

48. The aerogel material as claimed in claim 44, wherein the metals are selected from the group consisting of Al, Zr, Ti, La, V, Ta, Nb, Mn, Th, Ce, Pr, Nd, Eu, Gd, Tb, Sm, Dy, Ho, Er, Tm, Vb, Lu, Mg, Ca, Sr, Ba, Na, K, Rb.

49. The aerogel material as claimed in claim 44, wherein the metal is one or more metals selected from the group consisting Al, Zr and Ce.

50. A method for preparing the aerogel material of claim 38, the method comprising the steps of:
a) preparing a solution comprising at least one precursor of the at least one metal oxide or the composite thereof, in H₂O₂; additioned with an alcohol or an azeotropic mixture, consisting of H₂O and an alcohol,
b) adding the solution of step a) to a base to form a hydroalcogel and obtain a precipitate;
c) filtering off the precipitate obtained in step b); and
d) calcining thereof at a temperature within the range from 300° C. to 1100° C.

51. The method of claim 50, wherein in step a) the molar ratios of H₂O₂ to metal are between 2 and 12.

52. The method of claim 51, wherein in step a) the molar ratios of H₂O₂ to metal are between 3 and 6.

53. The method of claim 50, wherein the alcohols are selected from the group consisting of methyl alcohol, ethyl alcohol, propyl alcohol, isopropyl alcohol or azeotropic mixtures thereof with water.

54. The method of claim 53, wherein the alcohol is isopropyl alcohol.

55. The method of claim 50, wherein in the azeotropic mixture the alcohol quantity is between 25% and 90%.

56. The method of claim 50, wherein the ratios of the solution obtained in step a) are: [Metal]>0.1 M, [H₂O₂]1[Metai]˜1, 0.25<Volume(alcohol)/Volume(H2O).

57. The method of claim 50, wherein the base is concentrated ammonia.

58. The method of claim 57, wherein the ammonia is in a concentration of 25-30% in water.

59. The method of claim 58 wherein the base is further diluted in an alcohol or in an azeotropic mixture of alcohol and water.
